(19) United States
(12) Patent Application Publication
(10) Pub. No.: US 2013/0167934 A1
(43) Pub. Date: Jul. 4, 2013

(54) Adjusting Air Flow without Restricting a Fan

(71) Applicant: Bernard D. Regier, Newton, KS (US)

(72) Inventor: Bernard D. Regier, Newton, KS (US)

(73) Assignee: AGCO Corporation, Duluth, GA (US)

(21) Appl. No.: 13/338,307

(22) Filed: Dec. 28, 2011

(51) Int. Cl. F15D 1/00

(52) U.S. Cl. 137/1; 137/561 R

(57) ABSTRACT

A duct may be disclosed. The duct may comprise a wall and a cover. The wall may define a passage, an inlet in fluid communication with the passage, an outlet in fluid communication with the passage, and an opening in fluid communication with the passage. The cover may be arranged to selectively block the opening.

### CROSS-REFERENCE TO RELATED APPLICATIONS

The current application is related to U.S. patent application Ser. No. 13/338,287 filed on Dec. 28, 2011, entitled “Vented Fan Duct,” (Attorney Docket No. A1214H) and U.S. patent application Ser. No. 13/338,293 filed on Dec. 28, 2011, entitled “Multiple Fan Blade Angles in a Single Crossflow Fan,” (Attorney Docket No. A1220H), which are hereby incorporated by reference in its entirety.

### BACKGROUND

Equipment such as, for example, agricultural machines, may have a fan. The fan may be used to create airflow. The airflow may be used for various purposes such as, for example, cleaning and cooling equipment parts. The fan may be internal or external.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of a combine; and

FIG. 2 is a diagram of a fan assembly.

### DETAILED DESCRIPTION

### Overview

A duct may be disclosed. The duct may comprise a wall and a cover. The wall may define a passage, an inlet, an outlet, and an opening. The passage, the inlet, the outlet, and the opening may be in fluid communication with the passage. The cover may be arranged to selectively block the opening.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

A fan may be connected to a duct. The fan may produce an airstream. The air stream may have a constant velocity. However, at various times it may be desirable for the air stream's velocity to vary. To achieve a varying velocity, while maintaining a constant fan speed, a cover covering an opening in the duct may be repositioned.

While this disclosure describes ducts that may direct airflows in the context of a combine, embodiments are not limited to agricultural environment. In other words, applications where a varying airflow pattern may be desirable include not only agricultural equipment, but also include, for example, industrial and manufacturing applications.

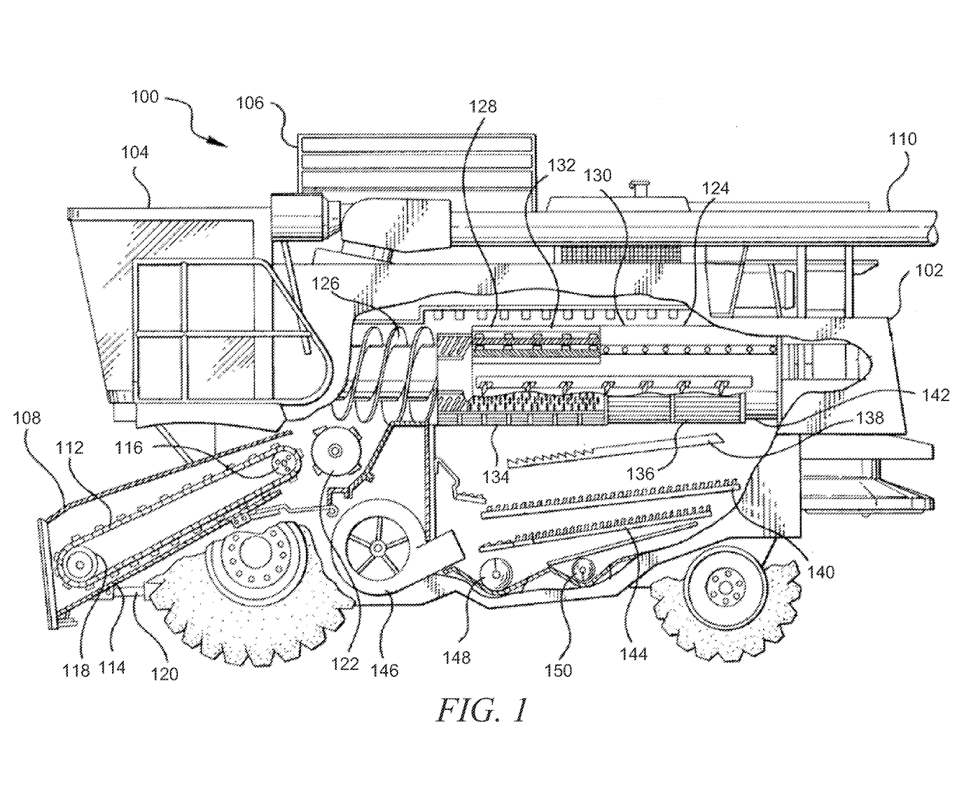

FIG. 1 is a diagram of a combine 100. Combine 100 may comprise a separator housing 102, an operator's work station and cab 104, a grain tank 106, and an elevator assembly 108. A swingable unloading auger assembly 110 may pivot to a position extending laterally outward to one side of combine 100 to unload grain tank 106. Unloading auger assembly 110 may swing inward to a storage position as shown in FIG. 1 when grain tank 106 is not being unloaded.

Elevator assembly 108 may have a conveyor 112 mounted in an elevator housing 114. Conveyor 112 may be trained around rear drive sprockets 116 and a front drum 118. Hydraulic linear actuators 120 may pivot elevator housing 114 to raise and lower the forward end of elevator housing 114.

Crop material may be fed to a feed beater 122 by conveyor 112 in elevator housing 114. Feed beater 122 may feed crop material to a separating rotor 124. Separating rotor 124 may comprise a feed section 126, a threshing section 128, and a separation section 130. Feed section 126 may move crop material in a spiral path about a generally horizontal fore and aft axis of rotation to separating rotor 124, toward threshing section 128. In threshing section 128, crop material may pass between a cylinder bar 132 and a concave 134 where grain may be threshed. Threshed grain, that is not separated by concave 134, may be separated in separation section 130 and may pass through a separation grate 136. A grain pan 138 may convey grain and chaff forward and may deposit it on a chaffer 140. Crop material other than grain (MOG) may be discharged from separating rotor 124 through a rotor discharge 142.

Grain and MOG that may pass through concave 134 and separation grate 136 may fall to upper grain pan 138. Grain pan 138 may convey grain and chaff forward and may deposit it on chaffer 140. The grain may be cleaned by chaffer 140 and a sieve 144 and air from a fan assembly 146. Chaff may be discharged from the rear of sieve 144 and chaffer 140. Clean grain may fall into a clean grain auger 148. The clean grain may be conveyed to grain tank 106 by clean grain auger 148 and an elevator (not shown). Tailings may fall into a returns auger 150 and may be conveyed to separating rotor 124 by returns auger and return elevators (not shown), where they may be threshed a second time.

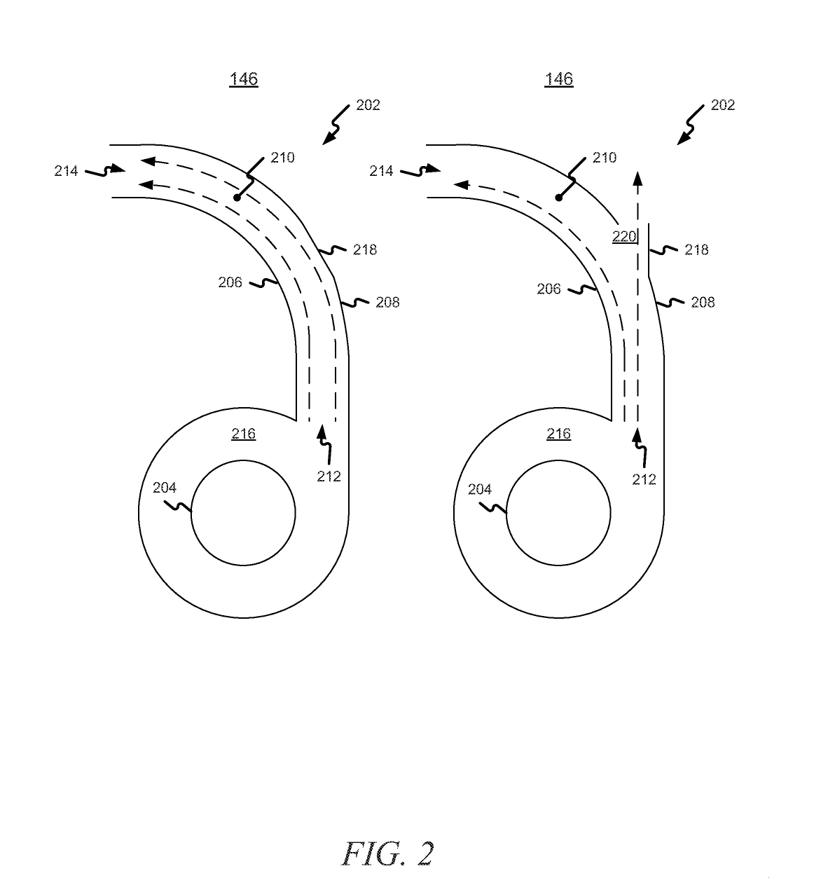

FIG. 2 is a diagram of a fan assembly 146. Fan assembly 146 may comprise a duct 202 and a fan 204. Duct 202 may comprise a first wall 206 and a second wall 208. First wall 206 and second wall 208 may define a passage 210. Passage 210 may comprise an inlet 212 and an outlet 214. Fan 204 may be located in a cavity 216. Cavity 216 may be located proximate inlet 212 and in fluid communication with duct 202 via inlet 212. Outlet 214 may be arranged to allow a fluid (e.g., air) to be at least partially directed toward sieve 144.

A cover 218 may be arranged to selectively block an opening 220. Second wall 208 may include a curved portion. The curved portion may be located between inlet 212 and outlet 214. Opening 220 may be defined by second wall 208 within the curved portion. Opening 220 may be defined proximate a beginning portion of the curved section. In addition, opening 220 may be defined proximate a tailing portion of the curved section.

Cover 218 may be pivotably connected to second wall 208. During operation, a fluid (e.g., air) may traverse passage 210 (as indicated by the dashed lines in FIG. 2) and cover 218 may be pivoted to differing positions. In other words, cover 218 may be arranged to selectively leave opening 220 substantially unobstructed. For example, cover 218 may be pivoted into a more open position (i.e., covering less of opening 220). The more open position may cause an increase in a size of opening 220 in passage 210. As the size of opening 220 increases a portion of the fluid traversing passage 210 may escape through opening 220. As the portion of the fluid escaping through opening 220 increases, the airflow through passage 210 may have a decreased flow rate.

In addition, cover 218 may be pivoted into a more closed position (i.e., covering more of opening 220). The more closed position may cause a decrease in the size of opening 220 in passage 210. As the size of opening 220 decreases the portion of the fluid escaping through opening 220 may decrease. As the portion of the fluid escaping through opening 220 decreases, the airflow through passage 210 may have an increased flow rate.

While FIG. 2 shows second wall 208 defining a single opening (i.e., opening 220), first wall 206 and/or second wall 208 may define a second opening (not shown) in fluid communication with passage 210. In addition, a second cover (not shown) may be arranged to selectively block the second opening.

The size of opening 220 may be adjustable. In addition, cover 218 may be located inside passage 210 or external to passage 210. Furthermore, cover 218 may be in direct contact with second wall 208 or cover 218 may be located proximate second wall 208, but still arranged to alter the fluid's airflow through passage 210.

The position of cover 218 may be fixed or adjustable during use. For instance, a user may set the position of cover 218 before using combine 100 and it may not be repositioned during use of combine 100. In addition, cover 218 may be adjustable during use. For instance, during operation airflow information, gathered by sensors located in passage 210, or any other location in separator housing 102 where air velocity may need to be controlled, may be transmitted to a processor and presented to the user, possibly on a display. The airflow information may include an airflow velocity or a velocity profile. The user may then be able to reposition cover 218 to alter the airflow velocity or the velocity profile.

An embodiment may comprise an apparatus. The apparatus may comprise a duct having a wall and a cover. The wall may define a passage, an inlet in fluid communication with the passage, an outlet in fluid communication with the passage, and an opening in fluid communication with the passage. The cover may be arranged to selectively block the opening.

Another embodiment may comprise an apparatus. The apparatus may comprise a combine having a sieve and a duct arranged to direct a fluid at least partially toward the sieve. The duct may comprise a duct having a wall and a cover. The wall may define a passage, an inlet in fluid communication with the passage, an outlet in fluid communication with the passage, and an opening in fluid communication with the passage. The cover may be arranged to selectively block the opening.

Yet another embodiment may comprise a method. The method may comprise: causing a fluid to traverse a passage; increasing a size of an opening in the passage; and decreasing a flow rate of the fluid upon increasing the size of the opening in the passage.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

What is claimed is:

1. An apparatus comprising:
a duct comprising,
a wall defining a passage,
an inlet in fluid communication with the passage,
an outlet in fluid communication with the passage, and
an opening in fluid communication with the passage;
a fan arranged to blow air into the inlet; and
a cover arranged to selectively block the opening.

2. The apparatus of claim 1, wherein the wall comprises a curved portion located between the inlet and the outlet, the opening being defined within the curved portion.

3. The apparatus of claim 2, wherein the opening is defined proximate a beginning portion of the curved portion.

4. The apparatus of claim 2, wherein the opening is defined proximate a tailing portion of the curved portion.

5. The apparatus of claim 1, wherein the cover is pivotably connected to the wall.

6. The apparatus of claim 1, wherein the cover is sized to selectively completely block the opening.

7. The apparatus of claim 1, wherein the cover is configured to partially block the opening.

8. The apparatus of claim 1, wherein the cover is arranged to selectively leave the opening substantially unobstructed.

9. The apparatus of claim 1,
wherein the wall further defines a second opening in fluid communication with the passage, and
further comprising a second cover, arranged to selectively block the second opening.

10. An apparatus comprising:
a combine having a sieve;
a duct comprising a wall, the wall defining:
a passage,
an inlet in fluid communication with the passage,
an outlet in fluid communication with the passage, and
an opening in fluid communication with the passage;
a fan arranged to blow a gas into the inlet, through the passage, out the outlet, the outlet arranged to direct the gas at least partially toward the sieve; and
a cover arranged to selectively block the opening.

11. The apparatus of claim 10, wherein the wall comprises a curved portion located between the inlet and the outlet, the opening being defined within the curved portion.

12. The apparatus of claim 11, wherein the opening is defined proximate a beginning portion of the curved portion.

13. The apparatus of claim 11, wherein the opening is defined proximate a tailing portion of the curved portion.

14. The apparatus of claim 10, wherein the cover is pivotably connected to the wall.

15. The apparatus of claim 10, wherein the cover is sized to selectively completely block the opening.

16. The apparatus of claim 10, wherein the cover is configured to partially block the opening.

17. The apparatus of claim 10, wherein the cover is arranged to selectively leave the opening substantially unobstructed.

18. The apparatus of claim 10,
wherein the wall further defines a second opening in fluid communication with the passage, and
further comprising a second cover, arranged to selectively block the second opening.

19. A method comprising:
causing a fluid to traverse a passage;
increasing a size of an opening in the passage; and
decreasing a flow rate of the fluid upon increasing the size of the opening in the passage.

20. The method of claim 19, further comprising:
decreasing the size of the opening in the passage; and
increasing the flow rate of the fluid upon decreasing the size of the opening in the passage.
